(19) United States
(12) Patent Application Publication
(10) Pub. No.: US 2024/0302573 A1
(43) Pub. Date: Sep. 12, 2024

(54) IR TRANSMISSIVE PANE

(71) Applicant: AGC GLASS EUROPE, Louvain-la-Neuve (BE)

(72) Inventors: Xavier LALOYAUX, Gosselies (BE); Philippe ROQUINY, Moustier-sur-Sambre (BE); Valérie FARINA, Profondeville (BE); Timothy Edward MADISON, Louvain-la-Neuve (BE)

(73) Assignee: AGC GLASS EUROPE, Louvain-la-Neuve (BE)

(21) Appl. No.: 18/578,224

(22) PCT Filed: Jul. 15, 2022
(86) PCT No.: PCT/EP2022/069864

§ 371 Date: Jan. 10, 2024

(30) Foreign Application Priority Data
Jul. 20, 2021 (EP) 21186784.1
Oct. 8, 2021 (EP) 21201740.4

(51) Int. Cl. G02B 1/115; G01S 7/481; G01S 17/88; G02B 5/20; G02B 5/28

(52) U.S. Cl. CPC G02B 1/115; G01S 7/4813; G01S 17/88; G02B 5/208; G02B 5/281

(57) ABSTRACT

An infrared transmissive pane comprising an infrared transmissive substrate and an infrared transmissive coating, optical assemblies comprising the pane, and uses of the pane.

### FIELD OF THE INVENTION

The present invention relates to an infrared transmissive pane comprising an infrared transmissive substrate and an infrared transmissive coating, and to optical assemblies comprising said pane, and to uses of said pane.

### BACKGROUND OF THE INVENTION

Infrared waves or rays have multiple sources and uses. Typical infrared rays originate from the sun at wavelengths greater than the visible range, that is greater than 780 nm (near infrared) up to 3 mm (far infrared).

A variety of applications, ranging from the detection of infrared (IR) signals, for instance in thermal imaging, to element identification in IR spectroscopy, make use of infrared light. A certain range of substrates is being used to manufacture optical elements that transmit, reflect and/or generally control the trajectory of IR light, such as plano-optics (i.e. windows, mirrors, polarizers, beamsplitters, prisms), spherical lenses (i.e. plano-concave/convex, double-concave/convex, meniscus), aspheric lenses (parabolic, hyperbolic, hybrid), achromatic lenses, and lens assemblies (i.e. imaging lenses, beam expanders, eyepieces, objectives). The bulk materials of these substrates for infrared applications vary in their physical, in particular optical, characteristics. As a result, knowing the benefits of each characteristic allows one to select the correct material for any IR application. Since infrared light is comprised of longer wavelengths than visible light, the two wavelength regions, visible and infrared, behave differently when propagating through the same optical medium. In general, certain materials can be used for both IR and visible applications, most notably fused silica, borosilicate glass, sapphire, alumina-silicate glass and certain soda-lime glasses, while others are used only for one or the other application. The foremost attribute defining any bulk material for infrared light is transmittance of infrared light. Transmittance is a measure of throughput and is given as a percentage of the incident light.

Some optical elements may be used for transmitting infrared light between a source and/or a receptor. Examples of such optical elements include cover glasses and optical elements, such as lenses, prisms, or mirrors to be used with infrared light.

Nowadays automotive vehicles are equipped with increasing optical receptors and optical elements, among which those having operating wavelength ranges in the infrared, for example of from 800 to 2000 nm, also sometimes referred to as “near-infrared” because of its proximity with the visible light spectrum ranging of from 350 to 780 nm. Automotive vehicles include car, van, lorry, motorbike, bus, tram, train, drone, airplane, helicopter and the like.

WO2018015312A1 concerns an automotive glazing comprising (i) at least one glass sheet having an absorption coefficient lower than 5 m⁻¹ in the wavelength range from 750 to 1050 nm and having an external face and an internal face, and (ii) an infrared filter. An infrared-based remote sensing device in the wavelength range from 750 to 1050 nm, is placed on the internal face of the glass sheet in a zone free of the infrared filter layer. Such device has to be protected from the external environment behind a glass sheet, such as a windshield, as it is not resistant to said external environment.

A particular example of such optical elements includes covers for infrared receptors, particularly used in the automotive field, such as infrared camera or lidar. Indeed, typically the receptor is placed behind a cover, to protect the receptor from the external environment. The detection limit of the receptor is evidently linked to the transmission level of the cover in the operating wavelength range of the receptor.

It is therefore needed to increase the transmission level of said cover in the infrared wavelength range. Such increase in transmission may typically be achieved with antireflective coatings comprising alternating layers of low refractive index material and high refractive index material, which will thus reduce the reflection of the incident light on the surface of the of the cover. Such a multilayer coating may typically improve the efficiency of the optical element by increasing the transmission of the infrared light through said coated substrate, enhancing contrast, and eliminating ghost images.

CN110218006B relates to laminated glass for a vehicle, which can be matched with a laser radar or a near infrared camera for use. The laminated glass comprises, among others, a antireflection film to reduce energy loss of near infrared light of a laser or near infrared camera. The operating wavelength of such antireflective coating is narrow, and thus not useful in various applications. Further, such laminated glass is not resistant to the external environment.

The multi-layer coatings, although effective to reduce IR reflectance, generally have lower durability than the substrate itself. Therefore, typically, the antireflective coating is placed on the internal face of the cover, meaning on the face of the cover facing the infrared receptor (while the external face faces the external environment).

The durability of antireflective coatings has so far not been sufficient to allow for their positioning on the external face of a cover, such as to maintain the optical performance during the lifetime of the product. Further, insofar the antireflective coating was positioned on the internal face of the cover, the colors in reflection in the visible range (with wavelengths from 350 to 780 nm) were not necessarily optimized.

In particular, it is difficult to obtain anti-reflective coatings for infrared radiation, in particular near-infrared light in the range between 800 and 2000 nm, while maintaining low visible light reflectance and/or reflected light colors that are close to neutral.

There thus remains a need for an antireflective coating with improved durability, with resistance to both physical and environmental damage and/or neutral color rendering and/or low light reflectance.

### SUMMARY OF THE INVENTION

The present invention provides for an infrared transmissive pane comprising a first infrared transmissive substrate having a first surface and a second surface opposite to the first surface, and an infrared antireflective coating on the first surface, said coating comprising S sequence(s) of thin layers,
wherein each sequence comprises a layer of high refractive index material underneath a layer of low refractive index material,
wherein S≥2,
   characterized in that the optical thickness e_{UL} at a wavelength λ_{IR}, of said coating's uppermost layer having a low refractive index material ranges of from

$$( {λ}_{IR} * 0.12 ) \leq {e}_{UL} \leq ( {λ}_{IR} * 0.4 ) ,$$

wherein λ_{IR} is an infrared wavelength selected in the range of from 800 to 2000 nm.

The present invention further provides for an optical assembly for infrared light in the range of from 800 to 2000 nm, comprising said infrared transmissive pane and at least one of an infrared sensitive receptor or an infrared light source, wherein the pane is configured to transmit infrared light to the receptor and/or from the source.

Last provided is the use of said infrared transmissive pane in a LIDAR.

### DETAILED DESCRIPTION OF THE INVENTION

The present invention provides for an infrared transmissive pane comprising a first infrared transmissive substrate having a first surface and a second surface opposite to the first surface, and an infrared antireflective coating on the first surface, said coating comprising S sequence(s) of thin layers,
wherein each sequence comprises a layer of high refractive index material underneath a layer of low refractive index material,
wherein S≥2,
   characterized in that the optical thickness e_{UL} at a wavelength λ_{IR}, of said coating's uppermost layer having a low refractive index material ranges of from

$$( {λ}_{IR} * 0.12 ) \leq {e}_{UL} \leq ( {λ}_{IR} * 0.4 ) ,$$

wherein λ_{IR} is an infrared wavelength selected in the range of from 800 to 2000 nm.

The infrared wavelength typically ranges of from 800 nm to more than 10 micrometers. However, the use of infrared technologies is typically processed at wavelengths in the near-infrared, that is, that range of the wavelength nearest to the visible wavelength, border to the red, namely ranging of from 800 to 2000 nm, which is the operating wavelength range considered for the present invention, also designated as λ_{IR}.

In the scope of the present invention, the terms “infrared rays”, “infrared light” and “infrared wavelengths” may be used interchangeably and encompass the same wavelength region ranging of from 800 to 2000 nm. That is, the present infrared antireflective coating has an operating wavelength ranging in the infrared, of from 800 to 2000 nm.

In the scope of the present invention, the terms “alternatively” and “preferably” may be used interchangeably.

In the scope of the present invention, the λ_{IR} is thus a selected operating infrared wavelength which is selected in the range of from 800 to 2000 nm. That is, λ_{IR} is a punctual value, selected in the range of from 800 to 2000 nm and is thus not an average value of wavelengths within said range.

In the scope of the present invention, operating wavelengths in the infrared region may specifically be of 850 nm, 905 nm, 940 nm, 1064 nm, 1310 nm, 1350 nm, 1550 nm, 1650 nm. These operating wavelengths will depend on the optical assembly making use of the present infrared transmissive pane. In a LIDAR for automotive applications, for example, operating wavelengths may be of 905 nm, or 1550 nm, among others. An acceptable variance of 25 nm around the nominal value of the wavelength may be considered, such that, for example, a wavelength range of 1525 to 1575 nm may be accepted around the nominal value of 1550 nm.

The infrared transmissive substrate is particularly chosen such that the infrared rays transmission is optimized. The substrates may be selected from glass, polymethylmethacrylate (PMMA), polycarbonate (PC), polyvinyl chloride (PVC), polyethylene (PE), polybutylene (PB) or mixtures and composites of two or more of polymethylmethacrylate (PMMA), polycarbonate (PC), polyvinyl chloride (PVC), polyethylene (PE), polybutylene (PB). A preferred substrate is glass.

The infrared transmissive substrate may have a thickness ranging of from 0.5 mm to about 15 mm, alternatively of from 1 mm to about 10 mm, alternatively of from 1 mm to about 8 mm, alternatively of from 1 mm to about 6 mm, alternatively of from 0.5 to 4 mm.

In the case of glass, the glass may a silica-based glass, such as soda-lime-silica, alumino-silicate or boro-silicate type glass.

Preferred glass types will be herein referred to as “infrared transmissive glass”, and are typically those having an absorption coefficient lower than 15 m⁻¹ in the wavelength range from 750 to 1650 nm, alternatively lower than 5 m⁻¹. To quantify the low absorption of the glass sheet in the infrared range, in the present description, the absorption coefficient is used in the wavelength range from 750 to 1650 nm.

Preferred substrates may thus be selected from infrared transmissive glass, for their long term resistance to exposure, their color stability and their low impact on the environment in terms of usage and recycling. The added advantage of glass is that the thickness of the sheet of glass may be tuned to reduce the overall weight of the pane.

The absorption coefficient is defined by the ratio between the absorbance and the optical path length traversed by electromagnetic radiation in a given environment. It is expressed in m⁻¹. It is independent of the thickness of the material but it is function of the wavelength of the absorbed radiation and the chemical nature of the material.

The absorption coefficient (μ) at a chosen wavelength λ can be calculated from a measurement in transmission (T) as well as the refractive index n of the material (thick=thickness), the values of n, ρ and T being a function of the chosen wavelength λ:

$$μ = - \frac{1}{thick} . ln [ \frac{- {( 1 - ρ )}^{2} + \sqrt{{( 1 - ρ )}^{4} + 4. {T}^{2} . {ρ}^{2}}}{2. T . {ρ}^{2}} ] \\ with ρ = {( n - 1 )}^{2} / {( n + 1 )}^{2} .$$

The glass sheet type according to the invention preferably has an absorption coefficient <15 m⁻¹, in the wavelength range of 750-1650 nm. Such glass type is generally used in optical technologies having operating wavelengths in the infrared range of 800 to 2000 nm, since a low absorption coefficient presents an additional advantage that the final IR transmission is less impacted by the optical path in the material. Preferably, the glass sheet has an absorption coefficient of lower than 5 m⁻¹, or lower than 3 m⁻¹, or even lower than 2 m⁻¹. Such as glass type may also be referred to as “extra clear” glass.

In some instances the glass may be colored glass, from green, blue or grey, up to black glass, provided the glass is transmissive for infrared rays of from 800 to 2000 nm. For example in LIDAR applications, the glass substrate may be infrared transmissive grey glass or infrared transmissive black glass.

Conventional “clear glass” typically has an absorption coefficient about 30 m⁻¹ order, significantly higher than the present preferred glass types.

Different compositions of glass may be suitable in the scope of the present invention, provided the absorption coefficient <15 m⁻¹ in the wavelength range from 750 to 1650 nm, alternatively lower than 5 m⁻¹, as discussed above.

The base glass composition of the invention may comprise a total content expressed in weight percentages of glass:

| | |
|---|---|
| SiO₂ | 55-85% |
| Al₂O₃ | 0-30% |
| B₂O₃ | 0-20% |
| Na₂O | 0-25% |
| CaO | 0-20% |
| MgO | 0-15% |
| K₂O | 0-20% |
| BaO | 0-20%. |

Alternatively, the base glass composition may comprise a total content expressed in weight percentages of glass:

| | |
|---|---|
| SiO₂ | 55-78% |
| Al₂O₃ | 0-18% |
| B₂O₃ | 0-18% |
| Na₂O | 0-20% |
| CaO | 0-15% |
| MgO | 0-10% |
| K₂O | 0-10% |
| BaO | 0-5%. |

Alternatively, the base glass composition may comprise a total content expressed in weight percentages of glass:

| | |
|---|---|
| SiO₂ | 60-75% |
| Al₂O₃ | 0-6% |
| B₂O₃ | 0-4% |
| Na₂O | 0-15% |
| CaO | 0-10% |
| MgO | 5-20% |
| K₂O | 0-10% |
| BaO | 0-5%. |

In addition to its basic composition, the glass may include other components according to the desired effect. In the scope of the present invention, a very transparent glass in the high infrared (IR), with weak or no impact on its aesthetic or its color, may be obtained by combining a low iron quantity and chromium in a range of specific contents in the glass composition.

The glass sheet composition may thus comprise a content, expressed as the total weight of glass percentages, of
Fe total (expressed as Fe₂O₃) in amounts of 0.002 to 0.06% and Cr₂O₃ in amounts of 0.0001 to 0.06%; or
Fe total (expressed as Fe₂O₃) in amounts of 0.002 to 0.06% and Cr₂O₃ in amounts of 0.0015 to 1% and Co in amounts of 0.0001 to 1%; or
Fe total (expressed as Fe₂O₃) in amounts of 0.02 to 1% and Cr₂O₃ in amounts of 0.002 to 0.5% and Co in amounts of 0.0001 to 0.5%; or
Fe total (expressed as Fe₂O₃) in amounts of 0.002 to 1% and Cr₂O₃ in amounts of 0.001 to 0.5% and Co in amounts of 0.0001 to 0.5% and Se in amounts of 0,0003 to 0.5%; or
Fe total (expressed as Fe₂O₃) in amounts of 0.002 to 0.06% and CeO₂ in amounts of 0.001 to 1%; or
Fe total (expressed as Fe₂O₃) in amounts of 0.002-0.06%; and one of the following components:
   manganese (calculated as MnO) in an amount ranging from 0.01 to 1% by weight;
   antimony (expressed as Sb₂O₃), in an amount ranging from 0.01 to 1% by weight;
   arsenic (expressed as As₂O₃), in an amount ranging from 0.01 to 1% by weight, or
   copper (expressed as CuO), in an amount ranging from 0.0002 to 0.1% by weight.

These types of glass having high transmission in the infrared are well known by the skilled person and need not be further described herein. Alternatives may exist, which may be suitable in the scope of the present invention, provided the absorption coefficient is <15 m⁻¹, alternatively lower than 5 m⁻¹, as discussed above.

The glass may be annealed, tempered, bent or heat strengthened glass.

Typical thermal treatments comprise heating the glazing to a temperature of at least 560° C. in air, for example between 560° C. and 700° C., in particular around 640° C. to 670° C., during around 3, 4, 6, 8, 10, 12 or even 15 minutes according to the heat-treatment type and the thickness of the glazing. The treatment may comprise a rapid cooling step after the heating step, to introduce a stress difference between the surfaces and the core of the glass so that in case of impact, the so-called tempered glass sheet will break safely in small pieces.

The glass may be flat or totally or partially curved to correctly fit with the particular design or shape required according to the end use. The curving and/or bending techniques are known, and will not be further described herein.

The substrate typically has two opposite surfaces, that is, a first surface and a second surface opposite to the first surface.

The infrared antireflective coating is present on the first surface.

In the scope of the present invention, thin films refer to layers of materials having a geometrical thickness of from 0.5 to 900 nm, or from 0.5 to 800 nm, or from 0.5 to 700 nm, or from 0.5 to 500 nm.

Such thin films may typically be formed using chemical vapor deposition (CVD), Plasma enhanced chemical vapor deposition (PECVD), Physical vapor deposition (PVD), magnetron sputtering, or the like.

In the scope of the present invention, the terms “below”, “underneath”, “under” indicate the relative position of a layer vis a vis a next layer, within the layer sequence starting from the substrate. In the scope of the present invention, the terms “above”, “upper”, “on top”, “on” indicate the relative position of a layer vis a vis a next layer, within the layer sequence starting from the substrate.

In the scope of the present invention, the infrared antireflective coating comprises S sequence(s) of thin layers, wherein a sequence comprises a layer of high refractive index material underneath a layer of low refractive index material. In order to ensure the optical path is optimized, it may be recommended to ensure contact between said high refractive index material underneath said layer of low refractive index material within a sequence. The sequences are then stacked upon one another, such that the coating comprises an alternation of layers of high and low refractive indices. In view of further optimizing the optical path, the sequences may also be in contact with one another. Each layer typically has a geometrical thickness <900 nm, alternatively <800 nm, alternatively <700 nm.

In the scope of the present invention, there are at least 2 sequences in the antireflective coating. Typically, there may be 2, 3, 4, 5 or more sequences. When an antireflective coating is defined herein by a number #of sequences, it is not intended to mean that further sequences may be considered to be present beyond the #number of sequences defined. The uppermost sequence of the antireflective coating is thus also the last sequence of said coating. Suitable antireflective coatings operating in the infrared range of from 800 to 2000 nm have been designed having 2, 3, 4 or more sequences as described below, combining the advantages of an achieved performance to reduce reflection while being processable at a reasonable production cost.

In the scope of the present invention, the uppermost sequence comprising a layer of high refractive index material underneath a layer of low refractive index material is thus also the last sequence of the antireflective coating, furthest from the substrate upwards. That is, the uppermost layer of low refractive index material is also the last layer of the antireflective coating, in contact with the environment.

Similarly, the lowermost sequence comprising a layer of high refractive index material underneath a layer of low refractive index material is also the first sequence of the antireflective coating, closest to the substrate upwards.

In the scope of the present invention, antireflective coatings comprising 2 or 3 sequences have been found to have high infrared transmission, while not being optimally designed for their color neutrality in the visible region or for the low light reflectance.

In the scope of the present invention, antireflective coatings comprising 4 or more sequences have been found to have high infrared transmission, while being optimally designed for their color neutrality in the visible region and for the low light reflectance (Rc≤11%).

In the scope of the present invention, a layer may comprise one or more sublayers. When a layer is qualified as low refractive index layer, it may comprise sublayers each having a low refractive index. When a layer is qualified as high refractive index layer, it may comprise sublayers each having a high refractive index.

In the scope of the present invention, a high refractive index material has a refractive index ≥1.8 alternatively ≥1.9, alternatively >2.0, at a wavelength of 550 nm.

In the scope of the present invention, a low refractive index material has a refractive index ≤1.7, alternatively ≤1.6, at a wavelength of 550 nm.

The refractive index at a wavelength of 550 nm of the high refractive index materials is higher than the refractive index of the low refractive index materials. The refractive indices of the high and low refractive index materials may differ by a value of at least 0.1, preferably by a value of at least 0.2, more preferably by a value of at least 0.25. Such a refractive index difference allows for an optimal material interface and so optimal transmission of infrared light is achieved.

However, when calculating the optical thickness in the infrared wavelength ranging of from 800 to 2000 nm, the refractive index of the material is used, as measured within said infrared wavelength region. Refractive indices are available in common tools available in the field of thin films, and may not be provided herein for each material. Sources include the CODE software used for thin film analysis and design and for optical thin film design, from WTheiss Hardware and Software.

Independently of the number of sequences, the antireflective coating may be provided with a base layer in contact with the substrate and in contact with the lowest layer having a high refractive index, also the lowermost layer having a high refractive index. Said optional base layer typically takes no part in the infrared antireflection properties of the antireflective coating. Such an optional base layer may be provided to secure adhesion of the coating to the substrate, and/or to prevent ion migration from the substrate which may deteriorate the overlying coating, such as may occur with glass substrates. The optional base layer may have any refractive index, and does not optically contribute to the antireflective effect of the present coating. That is, the base layer does not play a role as part in the antireflective function of the antireflective coating and is not part of the optical layer design. Preferably the optional base layer may have a refractive index similar to that of the substrate, that is, within a value of 0.3, as compared to the refractive index of the substrate.

Examples of base layers include silicon oxide.

When the present infrared antireflective coating comprises two sequences, that is, when S=2, the first layer having a high refractive index may be referred to as layer HA, the first layer of low refractive index above said HA layer may be referred to as layer LA, the second layer having a high refractive index above said LA may be referred to as layer HB, the second layer of low refractive index above said HB layer may be referred to as layer LB:
Substrate/HA/LA/HB/LB
or
Substrate/base layer/HA/LA/HB/LB.

In cases when S=2, the second layer of low refractive index layer LB may be referred to as the uppermost (and last) layer having a low refractive index UL, and the second layer of high refractive index layer HB may be referred to as the uppermost layer having a high refractive index UH. Similarly, the first layer of low refractive index layer LA may be referred to as the lowermost layer having a low refractive index, and the first layer of high refractive index layer HA may be referred to as the lowermost layer having a high refractive index.

When the present infrared antireflective coating comprises three sequences, that is, when S=3, the first layer having a high refractive index may be referred to as layer HA, the first layer of low refractive index above said HA layer may be referred to as layer LA, the second layer having a high refractive index above said LA may be referred to as layer HB, the second layer of low refractive index above said HB layer may be referred to as layer LB, the third layer having a high refractive index above said LB may be referred to as layer HC, the third layer of low refractive index above said HC layer may be referred to as layer LC:
Substrate/HA/LA/HB/LB/HC/LC
or
Substrate/base layer/HA/LA/HB/LB/HC/LC.

In cases when S=3, the third layer of low refractive index layer LC may be referred to as the uppermost (and last) layer having a low refractive index UL, and the second layer of high refractive index layer HC may be referred to as the uppermost layer having a high refractive index UH. Here again, the first layer of low refractive index layer LA may be referred to as the lowermost layer having a low refractive index, and the first layer of high refractive index layer HA may be referred to as the lowermost layer having a high refractive index.

When the present infrared antireflective coating comprises four sequences, that is, when S=4, the first layer having a high refractive index may be referred to as layer HA, the first layer of low refractive index above said HA layer may be referred to as layer LA, the second layer having a high refractive index above said LA may be referred to as layer HB, the second layer of low refractive index above said HB layer may be referred to as layer LB, the third layer having a high refractive index above said LB may be referred to as layer HC, the third layer of low refractive index above said HC layer may be referred to as layer LC, the fourth layer having a high refractive index above said LC may be referred to as layer HD, the fourth layer of low refractive index above said HD layer may be referred to as layer LD:
Substrate/HA/LA/HB/LB/HC/LC/HD/LD
or
Substrate/base layer/HA/LA/HB/LB/HC/LC/HD/LD.

In cases when S=4, the fourth layer of low refractive index layer LD may be referred to as the uppermost (and last) layer having a low refractive index UL, and the fourth layer of high refractive index layer HD may be referred to as the uppermost layer having a high refractive index UH. Yet again, the first layer of low refractive index layer LA may be referred to as the lowermost layer having a low refractive index, and the first layer of high refractive index layer HA may be referred to as the lowermost layer having a high refractive index.

When the present infrared antireflective coating comprises five sequences, that is, when S=5, the first layer having a high refractive index may be referred to as layer HA, the first layer of low refractive index above said HA layer may be referred to as layer LA, the second layer having a high refractive index above said LA may be referred to as layer HB, the second layer of low refractive index above said HB layer may be referred to as layer LB, the third layer having a high refractive index above said LB may be referred to as layer HC, the third layer of low refractive index above said HC layer may be referred to as layer LC, the fourth layer having a high refractive index above said LC may be referred to as layer HD, the fourth layer of low refractive index above said HD layer may be referred to as layer LD, the fifth layer having a high refractive index above said LD may be referred to as layer HE, the fifth layer of low refractive index above said HE layer may be referred to as layer LE:
Substrate/HA/LA/HB/LB/HC/LC/HD/LD/HE/LE
or
Substrate/base layer/HA/LA/HB/LB/HC/LC/HD/LD/HE/LE.

In cases when S=5, the fifth layer of low refractive index layer LE may be referred to as the uppermost (and last) layer having a low refractive index UL, and the fifth layer of high refractive index layer HE may be referred to as the uppermost layer having a high refractive index UH. Here again, the first layer of low refractive index layer LA may be referred to as the lowermost layer having a low refractive index, and the first layer of high refractive index layer HA may be referred to as the lowermost layer having a high refractive index.

The sequences follow a similar nomenclature when S>5.

When S≥2, the optical thickness e_{UL} of the uppermost layer having a low refractive index, of the infrared antireflective coating may range of from (λ_{IR}*0.12)≤e_{UL}≤(λ_{IR}*0.40), wherein λ_{IR} is an infrared wavelength selected in the range of from 800 to 2000 nm.

Such an optical thickness for the uppermost layer having a low refractive index allows for a suitable antireflective effect of the infrared wavelengths. When the optical thickness is <(λ_{IR}*0.12) or >(λ_{IR}*0.40), the incident infrared rays are reflected on the surface and the performance of the antireflective coating is not ensured at the optimal level and/o the color in reflection is unsuitable from the viewpoint of an external observer.

That is, when the operating wavelengths in the infrared region is selected among the wavelengths of 850 nm, 905 nm, 940 nm, 1064 nm, 1310 nm, 1350 nm, 1550 nm, 1650 nm, the optical thickness e_{UL} of the uppermost layer having a low refractive index is calculated using said selected operating wavelength. For example, at an operating wavelength of 905 nm, the optical thickness e_{UL} may range of from 108.6 to 362 nm; or at an operating wavelength of 1550 nm, the optical thickness e_{UL} may range of from 186 to 620 nm.

In embodiments compatible with the other present embodiments, when S≥2, the sum of the optical thicknesses of the layers of high refractive index material τe_{H}, of the infrared antireflective coating may range of from (λ_{IR}*0.10)≤Σe_{H}≤(λ_{IR}*0.55).

That is, when S=2 or 3, the sum of the optical thicknesses Zen of the layers of high refractive index material e_{HA}+e_{HB} (+e_{HC}) may range of from (λ_{IR}*0.10)≤Σe_{H}≤(λ_{IR}*0.55), alternatively of from (λ_{IR}*0.28)≤Σe_{H}≤(λ_{IR}*0.55), alternatively of from (λ_{IR}*0.35)≤Σe_{H}≤(λ_{IR}*0.50), alternatively of from (λ_{IR}*0.38)≤Σe_{H}≤(λ_{IR}*0.47).

That is, when S=4 or more, or specifically when S=4, the sum of the optical thicknesses Σe_{H} of the layers of high refractive index material may range of from (λ_{IR}*0.10)≤Σe_{H}≤(λ_{IR}*0.55), alternatively of from (λ_{IR}*0.10)≤Σe_{H}≤(λ_{IR}*0.45), alternatively of from (λ_{IR}*0.10)≤Σe_{H}≤(λ_{IR}*0.35). When S=4, Σe_{H}=e_{HA}+e_{HB}+e_{HC}+e_{HD}+e_{HE}, and so on, when S>4.

This provides for the additional advantage that the infrared transmission is further improved for either the coatings comprising 2 or 3 sequences, or coatings comprising 4 or more sequences, and possibly over a wider range of operation in the wavelength region encompassing a first specific operating wavelength. In those instances, the antireflective coating designed for one first specific operating wavelength may actually be suitable for a second or more specific operating wavelength. This allows for versatility in the design possibilities while however limiting the production changes, since one antireflective coating may serve multiple purposes.

When S=2 or 3, the ratio of sum of the optical thicknesses Σe_{L} of the layers having a low refractive index to the visible wavelength of 550 nm “Σe_{L}/550 nm” complies with the following equation regarding the selected infrared operating wavelength (λ_{IR})—in percentage:

$$( 0.0614 \times {λ}_{IR} ) - K 1 \leq Σ {e}_{L} / 550 nm \leq ( 0.0614 \times {λ}_{IR} ) - K 2 \\ with K 1 = 25 \% and K 2 = - 3 \% .$$

This ratio “Σe_{L}/550 nm” has been found to ensure an optimal infrared antireflective effect of the infrared antireflective coating having S=2 or 3.

Alternatively, K1 may be equal to 22%, or equal to 19%. Alternatively, K2 may be equal to 1%.

In embodiments compatible with the above, when S=2 or 3, the optical thickness e_{UL} of the upper (or last) layer having a low refractive index UL, layer LB or LC, of the infrared antireflective coating may be from (λ_{IR}*0.15)≤e_{UL}≤(λ_{IR}*0.33), preferably of from (λ_{IR}*0.20)≤e_{UL}≤(λ_{IR}*0.32), or of from (λ_{IR}*0.22)≤e_{UL}≤(λ_{IR}*0.29), or of from (λ_{IR}*0.24)≤e_{UL}≤(λ_{IR}*0.27)
and/or
the optical thickness e_{UH} of the uppermost layer having a high refractive index UH, of the infrared antireflective coating may range of from (λ_{IR}*0.25)≤e_{UH}≤(λ_{IR}*0.50), preferably of from (λ_{IR}*0.31)≤e_{UH}≤(λ_{IR}*0.42),
and/or
the optical thickness e_{LA} of the lower (or first) layer having a low refractive index LA, of the infrared antireflective coating may be e_{LA}≤(λ_{IR}*0.13), preferably of from (λ_{IR}*0.04)≤e_{LA}≤(λ_{IR}*0.07),
and/or
the optical thickness CHA of the lower (or first) layer having a high refractive index HA, of the infrared antireflective coating may be CHA S (λ_{IR}*0.15), preferably of from (λ_{IR}*0.02)≤e_{HA}≤(λ_{IR}*0.11), more preferably of from (λ_{IR}*0.03)≤e_{HA}≤(λ_{IR}*0.10).

When S=2 or 3, or specifically when S=2, and one or more of the above characteristics are provided, an optimal antireflective coating may be provided with a simple coating which is cost-effective and obtainable by standard deposition methods of thin films.

These independent variations in the various layers may optimize within the field of action for the various wavelengths in the infrared and provide for an antireflective coating which may perform suitably at a first selected operating infrared wavelength, and over a wider range of secondary operating infrared wavelengths.

In embodiments compatible with the present invention, when S≥4, the optical thickness e′ of the layers may be considered with the refractive index of the material at a wavelength of 550 nm, while the optical thickness e is considered at the infrared wavelength selected in the range of from 800 to 2000 nm. Indeed, for antireflective coatings with 4 or more sequences, it has been found advantageous to consider the optical thicknesses e′ of the layers in the visible region as they are found to provide for antireflective coatings for infrared wavelengths, having a neutral color in reflection in the visible. That is, the antireflective coating is optimized for maximal transmission of infrared rays of from 800 to 2000 nm, while exhibiting a neutral color from a point of view of an external observer in the visible wavelength range of from 350 to 780 nm (reflection coating side) and a low light reflection.

In the scope of the present invention, a neutral color in reflection is achieved when −4<a*<1 and −5<b*<1 are of neutral aspect in coating-side reflection (CIELAB values under illuminant D65), at the visible wavelengths of from 350 to 780 nm, at incident angles of from 0 to 60°.

The colors are also angularly stable, that is, Delta a* and Delta b* are <5, when measured between normal and 60º incidence.

In the scope of the present invention, a low light reflection on the coating side is considered when Rc≤11%.

Therefore, when S≥4, the optical thickness e′UH of the uppermost layer having a high refractive index UH, of the infrared antireflective coating may range of from 15 to 110 nm, preferably 15 to 105 nm, more preferably 20 to 100 nm.

When S≥4, the optical thickness e_{UL} of the uppermost layer having a low refractive index UL, of the infrared antireflective coating may also range of from (λ_{IR}*0.12)≤e_{UL}≤(λ_{IR}*0.40), preferably of from (λ_{IR}*0.15)≤e_{UL}≤(λ_{IR}*0.37), more preferably of from (λ_{IR}*0.19)≤e_{UL}≤(λ_{IR}*0.33). Such additional parameter further improves color neutrality and angular stability of said neutral color.

When S=4, both the ratio of the sum of the optical thicknesses of the layers of high refractive index material Σe_{H} (=e_{HA}+e_{HB}+e_{HC}+e_{HD}) to the selected λ_{IR}-ratio “(Σe_{H}/λ_{IR})” and
the ratio of the sum of the optical thicknesses of the layers of low refractive index material apart from the uppermost layer Σe_{L}−e_{LD} (=e_{LA}+e_{LB}+e_{LC}) to the selected λ_{IR}-ratio “(Σe_{L}−e_{LD})/λ_{IR}”
comply with the following equations regarding the selected infrared operation wavelength (λ_{IR})—in percentage:

$$( - 0.0017 \times {λ}_{IR} ) + K 3 \leq Σ {e}_{H} / {λ}_{IR} \leq ( - 0.0017 \times {λ}_{IR} ) + K 4 ,$$

with the minimum set at Σe_{H}/λ_{IR}≥5%,
and

$$( - 0.0017 \times {λ}_{IR} ) + K 3 \leq ( Σ {e}_{L} - {e}_{LD} ) / {λ}_{IR} \leq ( - 0.0017 \times {λ}_{IR} ) + K 4$$

with the minimum set at (Σe_{L}−e_{LD})/λ_{IR}≥5%
and with K3=30% and K4=50%.

The ratios “Σe_{H}/λ_{IR}” and “(Σe_{L}−e_{LD})/λ_{IR}” define the boundaries wherein the infrared antireflective coating having S=4 has been found to ensure an optimal infrared antireflective effect together with neutral color and light reflection Rc≤11%.

Alternatively, K3 may be equal to 32%, or equal to 34%. Alternatively, K4 may be equal to 48%, or equal to 47%.

This allows for the present antireflective coating to be positioned in an optical element or device facing the exterior and as such, that may be observed by an external viewer, since it has appreciable aesthetics and suitable infrared antireflective properties.

Further optimization may be achieved when S≥4, or when S=4, and
the optical thickness e′_{HA} of the lowermost layer having a high refractive index, of the infrared antireflective coating may range of from 15 to 38 nm, preferably of from 17 to 35 nm, and/or
the optical thickness e′_{LA} of the lowermost layer having a low refractive index, of the infrared antireflective coating may range of from 55 to 100 nm, preferably of from 60 to 95 nm.

When S≥4, or specifically when S=4, and one or more of the above independent characteristics are provided, further optimal antireflection effect is provided with the additional advantage that the colors in reflection in the visible wavelength range is neutral when observed at 0° (normal incidence) but also under angular incidence, up to 60°.

Still further optimization of the antireflection coating comprising 4 sequences may be provided within the boundaries of the optical thicknesses e′ as provided here below (with the refractive index of the material considered at 550 nm), such that color neutrality, low reflection (Rc) and infrared transmission are both optimized:

| Optical | | | | | |
|---|---|---|---|---|---|
| thickness | Range | Preferred range | | Most preferred range | |
| e′ (nm) | max | Min | max | Min | max |
| HD | ≤130 | 15 | 105 | 20 | 100 |
| LC | ≤120 | 40 | 95 | 45 | 90 |
| HC | ≤150 | 55 | 130 | 60 | 125 |
| LB | ≤100 | 30 | 80 | 35 | 75 |
| HB | ≤120 | 45 | 100 | 50 | 95 |
| LA | ≤120 | 55 | 100 | 60 | 95 |
| HA | ≤50 | 15 | 38 | 17 | 35 |
| Substrate | | | | | |

In the scope of the present invention, the layers with high refractive index are independently selected from at least one of the oxides of Zn, Sn, Ti, Nb, Zr, Hf, Ta, Ni, In, Al, Si, Ce, W, Mo, Sb, La and Bi and mixtures thereof, or the nitrides of Si, Al, Zr, B, Y, Ce and La and mixtures thereof, or from zinc selenide, zinc sulfide or zinc fluoride and mixture thereof.

In some preferred embodiments, when the pane may have to be submitted to a heat treatment, defined later, the layers with high refractive index are independently selected from:
an oxide of Zr, Nb, Sn, Zn or Ti;
a mixed oxide of two or more of Ti, Zr, Nb, Si, Sb, Sn, Zn, In;
a nitride of Si, Zr, Al, B;
a mixed nitride of two or more of Si, Zr, Al, B.

In further preferred embodiments, when the pane may have to be submitted to a heat treatment, and the production is to be simplified, the layers with high refractive index are independently selected from mixed oxide of titanium and zirconium, silicon nitride, mixed nitride of silicon and titanium, mixed nitride of silicon and zirconium, mixed nitride of silicon and hafnium, zirconium nitride, zirconium oxide, silicon doped zirconium oxide, mixed nitride of zirconium and boron, mixed oxide of zinc and tin, niobium oxide, aluminum doped zinc oxide.

In the scope of the present invention, the layers with low refractive index are independently selected from silicon oxide, silicon oxynitride, silicon oxycarbide, aluminum oxide, mixed silicon aluminum oxide, mixed silicon zirconium oxide, aluminium doped silicon oxide, boron doped silicon oxide, magnesium fluoride, magnesium oxide, aluminum fluoride, yttrium fluoride, or mixtures thereof.

In some preferred embodiments, when the pane may have to be submitted to a heat treatment, defined later, the layers with low refractive index are independently selected from silicon oxide, silicon oxynitride, silicon oxycarbide, aluminum oxide, mixed silicon aluminum oxide, mixed silicon zirconium oxide, aluminium doped silicon oxide, boron doped silicon oxide or mixtures thereof.

In the scope of the present invention, a dopant is present in amounts <10% wt of the material, while a mixed X and Y (or more) material comprises more than 15% wt of each X and Y (or more) in the mixed material.

In certain embodiments, compatible with the previous embodiments, the uppermost layer having a low refractive index of the antireflective coating comprising 2 or more sequences, may comprise at least one sublayer of mixed silicon zirconium oxide. The sublayer of mixed silicon zirconium oxide may comprise 5 to 50 mol % of zirconium oxide, preferably 8 to 20 mol %. Such sublayer of mixed silicon zirconium oxide may have a refractive index ≤1.7 at 550 nm, alternatively of from 1.55 to 1.65.

When such mixed silicon zirconium oxide is present in the uppermost layer of low refractive index, superior durability is imparted to the antireflective coating. The position of the sublayer as uppermost sublayer in the uppermost layer having a low refractive index provides for further durability and resistance against scratches and external conditions.

The uppermost sublayer of mixed silicon zirconium oxide may have a geometrical thickness ranging of from 3 to 200 nm, alternatively of from 4 to 150 nm. A geometrical thickness of the uppermost sublayer of mixed silicon zirconium oxide ranging of from 3 to 20 nm is however already sufficient to provide for the necessary superior durability. A thickness >20 nm allows for the tuning of the antireflective property of the antireflective coating. Said geometrical thickness is included in the overall optical thickness of the uppermost layer e_{UL} as discussed above.

This provides for applications of the infrared transmissive pane in optical assemblies where there is contact with the external environment, and/or where dust, rain or harsh conditions may occur. Antireflective coatings in the scope of the invention may be provided without such uppermost sublayer and however still be suitable for the initial antireflection purpose. Their durability may however be diminished. Therefore, preferred antireflective coatings in the scope of the invention may be provided with such uppermost sublayer and be suitable for the initial antireflection purpose with the added benefit of durability in the external environment. This will thus determine in which type of applications. The present antireflective coating may be thus be used in various types of applications, exposed or non-exposed to the external environment.

The deposition methods of the different layers of the antireflective coating include chemical vapor deposition (CVD), Plasma enhanced chemical vapor deposition (PECVD), Physical vapor deposition (PVD), magnetron sputtering, wet coating, etc. Different layers may be deposited using different techniques.

In some embodiments, the low refractive index layers may be deposited by a PECVD method, such as hollow cathode PECVD method. This method provides for the added benefit of reduced cost and high deposition rate.

In some embodiments, compatible with the other embodiments, the infrared transmissive pane of the present invention may further comprise a heating system. Such heating system includes heating film or printed heating systems. The heating system may be provided on the first surface of the infrared transmissive pane, either above or below the antireflective coating, or may be positioned on the second surface of the infrared transmissive pane. Such heating system should not impair the purpose of the present infrared transmissive pane, and possibly be as thin as technically feasible.

Printed heating systems may be obtained using carbon, or silver, or copper based printed circuits and/or thin wires on non-planar substrates (typically plastic) or conductive inks. These are known to the skilled person and will not be further described herein.

Infrared transparent conductive film are known to the skilled person and will not be further described herein. An example of such film is the Canatu Carbon NanoBud heater from Canatu Corp.

The heating system should be chosen such as to allow the infrared transmission as intended for the end use. Such a heating system may be provided such that the pane may be de-iced or de-frosted, according to the end use.

In some first specific embodiments, the infrared transmissive pane of the present invention comprising a first infrared transmissive substrate having a first surface and a second surface opposite to the first surface, and an infrared antireflective coating on the first surface as the discussed above in its various embodiments, may further comprise a second infrared antireflective coating on the second surface opposite to the first surface.

In such first specific embodiments, the first and second infrared antireflective coatings may be the same or different.

In such first specific embodiments, the infrared transmissive pane bearing an infrared antireflective coating on each of its first and second surfaces is preferably not provided in the other embodiments where the pane is laminated with a second pane as described hereunder.

In a second specific embodiments, the infrared transmissive pane of the present invention comprising a first infrared transmissive substrate having a first surface and a second surface opposite to the first surface, and an infrared antireflective coating only on the first surface as discussed above, may further comprise an interlayer and a second infrared transmissive substrate having a first and a second surface opposite the first surface, laminated, by its second surface to the second surface of the first infrared transmissive substrate, by means of said interlayer.

In such second specific embodiments, the second surface of the first infrared transmissive substrate preferably does not bear an infrared antireflective coating. The presence of an antireflective coating in contact with the interlayer does not appear to bring about any additional effect and is thus preferably avoided.

The second infrared transmissive substrate may be the same or different as the first infrared transmissive substrate, and may be selected from glass, polymethylmethacrylate (PMMA), polycarbonate (PC), polyvinyl chloride (PVC), polyethylene (PE), polybutylene (PB) or mixtures and composites of two or more of polymethylmethacrylate (PMMA), polycarbonate (PC), polyvinyl chloride (PVC), polyethylene (PE), polybutylene (PB).

That is, the first and/or second infrared transmissive substrate may independently be selected from glass, polymethylmethacrylate (PMMA), polycarbonate (PC), polyvinyl chloride (PVC), polyethylene (PE), polybutylene (PB), or mixtures and composites of two or more of polymethylmethacrylate (PMMA), polycarbonate (PC), polyvinyl chloride (PVC), polyethylene (PE), polybutylene (PB).

The thicknesses of both infrared transmissive substrates may independently range, as discussed above, of from 0.5 mm to about 15 mm, alternatively of from 1 mm to about 10 mm, alternatively of from 1 mm to about 8 mm, alternatively of from 1 mm to about 6 mm, alternatively of from 0.5 to 4 mm.

The thicknesses of both infrared transmissive substrates may be the same or different.

Both substrates may thus have the same thickness, for example 0.5 mm, or 0.8 mm, or 1.2 mm, or 1.6 mm, or 2.1 mm, or 3 mm. Such symmetrical construction allows for ease of process and conventional sizing of the laminating process.

Both substrates may also have different thicknesses, for example pane 1=0.5 mm and pane 2=2.1 mm, or pane 1=0.8 mm and pane 2=2.1 mm, or pane 1=0.5 mm and pane 2=1.6 mm, pane 1=0.8 mm and pane 2=1.6 mm, or pane 1=1.6 mm and pane 2=2.1 mm. Such asymmetrical constructions allow for flexibility in curvature, and/or in weight management and/or flexibility in infrared transmissivity.

The colors of both substrates may be the same or different, as discussed above.

The two substrates may preferably be selected from infrared transmissive glass, for their long term resistance to exposure, their color stability and their low impact on the environment in terms of usage and recycling. The added advantage of glass is that the thicknesses of the sheets of glass may be tuned to reduce the overall weight of the pane, and may be the same or different for the two substrates.

The preferred glass of the infrared transmissive pane may be “infrared transmissive glass” as described above, having an absorption coefficient lower than 15 m⁻¹ in the wavelength range from 750 to 1650 nm, alternatively lower than 5 m⁻¹.

The glass substrate may be infrared transmissive grey glass or infrared transmissive grey black glass.

The interlayer providing for adhesion is typically selected from polyvinyl acetal, polyvinyl butyral, polyurethane, poly(ethylene-co-vinyl acetate), polyvinylchloride, poly(vinylchloride-co-methacrylate), polyethylenes, polyolefins, ethylene acrylate ester copolymers, poly(ethylene-co-butyl acrylate), silicone elastomers, epoxy resins, an acid copolymers, or mixtures thereof. Preferably, the interlayer may be selected from ethylene vinyl acetate and/or polyvinyl butyral and/or polyethyleneterephthalate, provided they do not negatively impact the functioning of the present infrared transmissive pane.

In some instances, the interlayer may be a colored interlayer such as grey or black, provided it allows for infrared transmission. Such colored interlayer may provide for superior aesthetics from an outside observer's viewpoint.

The interlayer may have a uniform thickness throughout its surface between the two panes, or may have a non-uniform thickness throughout its surface, that is, the interlayer may be a “wedge” interlayer.

The first and second substrates may be assembled by a lamination step for flat substrates, or by a bending step for curved substrates, which bending step includes the steps of first bending the panes and second, laminating said bent panes. These processes are known in the art and will not be described herein. Specific lamination step at room temperature may also be used, as they will allow for flexible and variable shapes that are easily achievable, such as cold bending, or balmy bending, which are suitable for pieces of substrates and specifically glass substrates, which have sizes <1 or 2 m².

The present infrared transmissive pane may thus be a monolithic pane, or a laminated pane.

Typically, a monolithic pane comprises an outer surface (P1) and an inner surface (P2).

Typically, a laminated pane comprises an outer pane having a first surface (P1) and a second surface (P2′), and an inner pane having a first surface (P3′) and a second surface (P4). The outer pane of the laminated glazing is that pane in contact with the exterior of a defined space (vehicle or building). The inner pane is that pane in contact with the inner space of said defined space. The two panes are held in contact with a laminating sheet or interlayer, serving the adhesion and contact between the two sheets of glass. The interlayer provides for the contact between the first surface of the inner pane (P3′) and the second surface of the outer pane (P2′).

In some embodiments, compatible with the previous second specific embodiments, the first surface of the second infrared transmissive substrate may be provided with a second infrared antireflective coating as discussed above.

In such instances, the first and second infrared antireflective coating may be the same or different.

In instances when the infrared transmissive pane is a monolithic infrared transmissive pane, an antireflective coating may thus be present on one or both of P1 and P2 surfaces. In such instances, the optional heating system may be present on either one of P1 or P2 surfaces, below or above the antireflective coating.

In instances when the infrared transmissive pane is a laminated infrared transmissive pane, an antireflective coating may thus be present on both P1 and P4 surfaces. In such instances, the optional heating system may be present on either one of P1 or P4 surfaces, below or above the antireflective coating, or be present on either one of P2′ or P3′ surfaces, in contact with the interlayer or within the interlayer. No antireflective coating is present on either one of the P2′ or P3′ surfaces.

The monolithic infrared transmissive pane or the laminated infrared transmissive pane may thus comprise a first infrared antireflective coating optimized for transmission at a specific operating infrared wavelength and to a neutral color in reflection (in the visible) on the P1 surface, while the second infrared antireflective coating may be optimized only for transmission at a specific operating infrared wavelength, on the P2 or P4 surface. In other instances, it may be required that the first coating be optimized for transmission at a specific operating infrared wavelength, to a neutral color in reflection (in the visible) and to durability for exposure to the external environment on the P1 surface, while the second antireflective coating may not require the same durability on the P2 or P4 surface.

One advantage of such embodiments is that the present antireflective coating may be designed to exhibit flexibility in terms of required performances in the end application. That is, both antireflective coatings may be designed optimally for efficiency and cost purposes.

The monolithic infrared transmissive pane or the laminated infrared transmissive pane may be provided with a opacifying coating, such as enamel or paint. Such enamel or paint may be applied on the glazing by screen printing, roller coating, spraying, curtain coating, decal application, or the like, optionally in presence of masking or shape/shadow defining elements, as is known by the skilled person. Such enamel or paint may provide for superior aesthetics and may be tuned to the surrounding area of the infrared transmissive pane.

The present invention also provides for an optical assembly comprising the infrared transmissive pane described in the above embodiments, and at least one of an infrared sensitive receptor or an infrared light source, wherein the pane is configured to transmit infrared light to the sensor and/or from the source.

In the scope of the present invention, an infrared sensitive receptor and an infrared light source are meant for devices having operating wavelengths ranging of from 800 to 2000 nm.

An infrared sensitive receptor may also be referred to as a receiving infrared optical sensor, that is, a sensor which does not emit an infrared optical signal, but is able to receive an infrared optical signal. A camera is a typical example of an infrared sensitive receptor, or receiving infrared optical sensor.

An infrared light source may also be referred to as an emitting infrared optical sensor, that is, a sensor which does not receive an infrared optical signal, but is able to emit an infrared optical signal.

In some embodiments, the optical assembly may comprise both the infrared sensitive receptor and the infrared light source. Such combined receptor and source may be referred to as an emitting/receiving infrared optical sensor.

Such emitting/receiving infrared optical sensor typically means a sensor first emitting an infrared optical signal from a vehicle towards the outside of the vehicle and then receiving an infrared optical signal reflected by some obstacle outside of the vehicle. A lidar is a typical example of an emitting/receiving near-infrared optical sensor.

The present optical assembly may thus comprise the infrared transmissive pane as discussed above, and an emitting/receiving infrared optical sensor.

The present optical assembly is mounted such that the infrared sensitive receptor and/or the infrared light source, or the emitting/receiving infrared optical sensor, are preferably located in a housing, facing an inner surface (1i) of the infrared transmissive pane according to the invention and comprising an opposite outer surface (1o) facing an exterior environment.

The present infrared transmissive pane is thus configured to transmit infrared light to the receptor and/or from the source in the optical assembly. The present pane, provided with the antireflective coating described above may thus have improved infrared light transmission such that the functioning of the receptor and/or source is optimized at the selected operating infrared wavelength λ_{IR}.

In instances where the first surface of the infrared transmissive pane comprising the antireflective coating, is the inner surface (1i), also referred to as P2 when monolithic or P4 when laminated, according to the above, this means the antireflective coating will not be subjected to the external environment.

In instances where the first surface of the infrared transmissive pane comprising the antireflective coating, is the outer surface (1o), also referred to as P1 according to the above, this means the antireflective coating might be subjected to the external environment.

In instances where the infrared transmissive pane comprises an antireflective coating on two sides (the same or different), one antireflective coating will be facing the outer surface (1o) or P1, and might be subjected to the external environment, while the other antireflective coating will be facing the inner surface (1i), P2 when monolithic or P4 when laminated.

The advantage of the infrared transmissive pane according to the different embodiments described herein, is that it may be designed in order to suit the requirements of a variety of applications, which require high infrared light transmission, optionally together with color neutrality and/or high durability.

The present invention provides for a cover for an infrared sensitive sensor and/or an infrared light source for infrared light in the range of from 800 to 2000 nm comprising the present infrared transmissive pane.

The use of the present infrared transmissive pane as a cover for an infrared sensor and/or infrared light source, or for an emitting/receiving infrared optical sensor, is also provided.

Such sensor is usually placed behind a cover. This cover protects the sensor from the external environment. It can be designed as a cover only, thereby closing the housing in which the sensor is placed. Or it can be a part of an integration element: for example the sensor can be placed behind an interior or exterior trim element, and the cover is therefore a portion of this interior or exterior trim element. An interior trim element of a vehicle is defined as glass or plastic molding, frame and other decorative addition to vehicle bodies and interiors, such as instrument panels, airbag covers, door trims, armrests, centre consoles, pillar trims, trim strips, seatbelt guides or roof handles. An exterior trim element includes bumpers, window/door seals, wheel wells, and headlights. Manufacturers use these to add aesthetics, increase function, and add flexibility to the vehicle design. The cover is of course transparent to the operating infrared wavelength of the sensor. Transparency of the cover to visible wavelengths is not mandatory.

The detection limit of the sensor is evidently linked to the transmission level of the cover in the operating wavelength range of the sensor. It is therefore needed to increase the transmission level of the cover in the near-infrared wavelength range.

The infrared transmissive pane according to the different embodiments described herein, is thus perfectly suitable as a cover for such sensor, as it may be designed in order to transmit infrared light optimally by improving transmission at a specific operating wavelength, when comprising an infrared antireflective coating comprising 2 or more sequences comprising a layer of high refractive index material underneath a layer of low refractive index.

The requirement of color neutrality may be tuned in instances where the cover might be visible to an external observer, by using an infrared transmissive pane comprising an infrared antireflective coating comprising 4 or more sequences comprising a layer of high refractive index material underneath a layer of low refractive index.

The requirement of durability may be ensured by the uppermost layer uppermost layer of low refractive index material comprises an uppermost layer of SiZrOx having a refractive index <1.7, when the sensor is integrated in a part of a vehicle which may endure harsh external conditions, such as a bumper or other exposed piece of equipment.

The present invention provides for a LiDAR device comprising the cover as described herein.

The present invention thus also provides for the use of the infrared transmissive pane in a LIDAR.

The present pane allows for the use of such a LIDAR without further transparent or opaque pane of the vehicle, such as a windscreen, backlite, sidelite or pillars.

Indeed, the optical assembly, cover and LiDAR provided with the present infrared transmissive pane, may be mounted on an exterior of an automotive vehicle, where it may be exposed to an aggressive environment exposed to rain, hail, large temperature variations, and impacts with various objects including gravel.

The present infrared transmissive pane may thus be useful in transportation applications or architectural applications, where infrared transmission may be used. Architectural applications include displays, windows, doors, partitions, shower panels, and the like.

Transportation applications include those vehicles for transportation on road, in air, in and on water, in particular cars, busses, trains, ships, aircraft, spacecraft, space stations, drones, and other motor vehicles. By vehicle, it is thus meant a passenger vehicle, truck, car, van, lorry, motor bike, bus, tram, train, airplane, helicopter, watercraft or the like.

The present invention therefore last provides for a vehicle comprising the optical assembly or the LiDAR according to the above.

### Clauses

The present invention may be described by the following clauses.

Clause 1: An infrared transmissive pane comprising a first infrared transmissive substrate having a first surface and a second surface opposite to the first surface, and an infrared antireflective coating on the first surface, said coating comprising S sequence(s) of thin layers,
wherein each sequence comprises a layer of high refractive index material underneath a layer of low refractive index material,
wherein S≥2,
   characterized in that the optical thickness e_{UL} at a wavelength λ_{IR}, of said coating's uppermost layer of low refractive index material ranges of from

$$( {λ}_{IR} * 0.12 ) \leq {e}_{UL} \leq ( {λ}_{IR} * 0.4 ) ,$$

wherein λ_{IR} is an infrared wavelength selected in the range of from 800 to 2000 nm

Clause 2: The infrared transmissive pane according to clause 1, wherein S≥2, and wherein the sum of the optical thicknesses at a wavelength λ_{IR} of the layers of high refractive index material Σe_{H}, of the infrared antireflective coating, ranges of from (λ_{IR}*0.10)≤Σe_{H}≤(λ_{IR}*0.55).

Clause 3: The infrared transmissive pane according to clause 1, wherein S=2 or 3, and wherein the sum of the optical thicknesses at a wavelength λ_{IR} of the layers of high refractive index material Σe_{H}, of the infrared antireflective coating, ranges of from (λ_{IR}*0.28)≤Σe_{H}≤(λ_{IR}*0.55), alternatively of from (λ_{IR}*0.35)≤Σe_{H}≤(λ_{IR}*0.50), alternatively of from (λ_{IR}*0.38)≤Σe_{H}≤(λ_{IR}*0.47).

Clause 4: The infrared transmissive pane according to any one of clause 1 to 3, wherein S=2 or 3, wherein the ratio of sum of the optical thicknesses Σe_{L} of the layers having a low refractive index to the visible wavelength of 550 nm “Σe_{L}/550 nm” complies with the following equation regarding the selected infrared operating wavelength (λ_{IR})—in percentage:

$$( 0.0614 \times {λ}_{IR} ) - K 1 \leq Σ {e}_{L} / 550 nm \leq ( 0.0614 \times {λ}_{IR} ) - K 2 \\ with K 1 = 25 \% and K 2 = - 3 \% .$$

Clause 5: The infrared transmissive pane according to clause 4, wherein K1=25%.

Clause 6: The infrared transmissive pane according to clause 4, wherein K2=−3%.

Clause 7: The infrared transmissive pane according to any one of clauses 1 to 4, wherein S=2 or 3, and the optical thickness e_{UL} at a wavelength λ_{IR} of the uppermost layer having a low refractive index, of the infrared antireflective coating ranges of from (λ_{IR}*0.15)≤e_{UL}≤(λ_{IR}*0.33), preferably of from (λ_{IR}*0.20)≤e_{UL}≤(λ_{IR}*0.32), or of from (λ_{IR}*0.22)≤e_{UL}≤(λ_{IR}*0.29), or of from (λ_{IR}*0.24)≤e_{UL}≤(λ_{IR}*0.27).

Clause 8: The infrared transmissive pane according to any one of clauses 1 to 4, wherein S=2 or 3, and the optical thickness e_{UH} at a wavelength λ_{IR} of the uppermost layer having a high refractive index, of the infrared antireflective coating ranges of from (λ_{IR}*0.25)≤e_{UH}≤(λ_{IR}*0.50), preferably of from (λ_{IR}*0.31)≤e_{UH}≤(λ_{IR}*0.42).

Clause 9: The infrared transmissive pane according to any one of clauses 1 to 4, wherein S=2 or 3, and the optical thickness e_{LA} at a wavelength λ_{IR} of the lowermost layer having a low refractive index LA, of the infrared antireflective coating is e_{LA}≤(λ_{IR}*0.13), preferably of from (λ_{IR}*0.04)≤e_{LA}≤(λ_{IR}*0.07).

Clause 10: The infrared transmissive pane according to any one of clauses 1 to 4, wherein S=2 or 3, and the optical thickness e_{HA} at a wavelength λ_{IR} of the lowermost layer having a high refractive index HA, of the infrared antireflective coating is e_{HA}≤(λ_{IR}*0.15), preferably of from (λ_{IR}*0.02)≤e_{HA}≤(λ_{IR}*0.11), more preferably of from (λ_{IR}*0.03)≤e_{HA}≤(λ_{IR}*0.10).

Clause 11: The infrared transmissive pane according to clause 1 or 2, wherein S=4, and wherein the sum of the optical thicknesses at a wavelength λ_{IR} of the layers of high refractive index material Σe_{H}, of the infrared antireflective coating, ranges of from (λ_{IR}*0.10)≤Σe_{H}≤(λ_{IR}*0.45), alternatively of from (λ_{IR}*0.10)≤Σe_{H}≤(λ_{IR}*0.35).

Clause 12: The infrared transmissive pane according to any one of clause 1, 2 or 11, wherein S≥4, and the optical thickness e′UH of the uppermost layer having a high refractive index UH, of the infrared antireflective coating ranges of from 15 to 110 nm preferably 15 to 105 nm, more preferably 20 to 100 nm.

Clause 13: The infrared transmissive pane according to any one of clauses 1, 2, 11 or 12, wherein S≥4, and the optical thickness e_{UL} of the uppermost layer having a low refractive index UL, of the infrared antireflective coating may also range of from (λ_{IR}*0.15)≤e_{UL}≤(λ_{IR}*0.37), preferably of from (λ_{IR}*0.19)≤e_{UL}≤(λ_{IR}*0.33).

Clause 14: The infrared transmissive pane according to any one of clause 1, 2, 11 to 13, wherein S=4, and both the ratio of the sum of the optical thicknesses of the layers of high refractive index material Σe_{H} (=e_{HA}+e_{HB}+e_{HC}+e_{HD}) to the selected λ_{IR}-ratio “(Σe_{H}/λ_{IR})”
and
the ratio of the sum of the optical thicknesses of the layers of low refractive index material apart from the uppermost layer Σe_{L}−e_{LD} (=e_{LA}+e_{LB}+e_{LC}) to the selected λ_{IR}-ratio “(Σe_{L}−e_{LD})/λ_{IR}”
comply with the following equations regarding the selected infrared operation wavelength (λ_{IR})—in percentage:

$$( - 0.0017 \times {λ}_{IR} ) + K 3 \leq Σ {e}_{H} / {λ}_{IR} \leq ( - 0.0017 \times {λ}_{IR} ) + K 4 ,$$

with the minimum set at Σe_{H}/λ_{IR}≥5%,
and

$$( - 0.0017 \times {λ}_{IR} ) + K 3 \leq ( Σ {e}_{L} - {e}_{LD} ) / {λ}_{IR} \leq ( - 0.0017 \times {λ}_{IR} ) + K 4$$

with the minimum set at (Σe_{L}−e_{LD})/λ_{IR}≥5%
and with K3-30% and K4=50%.

Clause 15: The infrared transmissive pane according to clause 14, wherein K3=32%, alternatively 34%.

Clause 16: The infrared transmissive pane according to clause 14, wherein K4=48%, alternatively 47%.

Clause 17: The infrared transmissive pane according to any one of clauses 1, 2, 11 to 14, wherein, S≥4 or S=4, and the optical thickness e′_{HA} of the lowermost layer having a high refractive index, of the infrared antireflective coating ranges of from 15 to 38 nm, preferably of from 17 to 35 nm.

Clause 18: The infrared transmissive pane according to any one of clauses 1, 2, 11 to 14, or 17, wherein, S≥4 or S=4, and the optical thickness e′_{LA} of the lowermost layer having a low refractive index, of the infrared antireflective coating ranges of from 55 to 100 nm, preferably of from 60 to 95 nm.

Clause 19: The infrared transmissive pane according to any one of clauses 1 to 18, wherein the layers with high refractive index are independently selected from at least one of the oxides of Zn, Sn, Ti, Nb, Zr, Hf, Ta, Ni, In, Al, Si, Ce, W, Mo, Sb, La and Bi and mixtures thereof, or the nitrides of Si, Al, Zr, B, Y, Ce and La and mixtures thereof, or from zinc selenide, zinc sulfide or zinc fluoride and mixture thereof.

Clause 20: The infrared transmissive pane according to any one of clauses 1 to 19, wherein the layers with high refractive index are independently selected from:
an oxide of Zr, Nb, Sn, Zn or Ti;
a mixed oxide of two or more of Ti, Zr, Nb, Si, Sb, Sn, Zn, In;
a nitride of Si, Zr, Al, B;
a mixed nitride of two or more of Si, Zr, Al, B.

Clause 21: The infrared transmissive pane according to any one of clauses 1 to 20, wherein the layers with low refractive index are independently selected from silicon oxide, silicon oxynitride, silicon oxycarbide, aluminum oxide, mixed silicon aluminum oxide, mixed silicon zirconium oxide, aluminium doped silicon oxide, boron doped silicon oxide, magnesium fluoride, magnesium oxide, aluminum fluoride, yttrium fluoride, or mixtures thereof.

Clause 22: The infrared transmissive pane according to any one of clauses 1 to 21, wherein the layers with low refractive index are independently selected from silicon oxide, silicon oxynitride, silicon oxycarbide, aluminum oxide, mixed silicon aluminum oxide, mixed silicon zirconium oxide, aluminum doped zinc oxide aluminium doped silicon oxide, boron doped silicon oxide, or mixtures thereof.

Clause 23: The infrared transmissive pane according to any one of clauses 1 to 22, wherein the uppermost layer having a low refractive index comprises at least one sublayer of mixed silicon zirconium oxide.

Clause 24: The infrared transmissive pane according to clause 23, wherein the at least one sublayer of mixed silicon zirconium oxide is the uppermost sublayer of the uppermost layer having a low refractive index.

Clause 25: The infrared transmissive pane according to any one of clauses 1 to 24, further comprising a transparent heating system.

Clause 26: The infrared transmissive pane according to clause 25, where the heating system is provided on the first surface of the infrared transmissive pane, either above or below the antireflective coating, or on the second surface of the infrared transmissive pane.

Clause 27: The infrared transmissive pane according to any one of clauses 1 to 26, further comprising a second infrared antireflective coating on the second surface opposite to the first surface.

Clause 28: The infrared transmissive pane according to any one of clauses 1 to 27, further comprising an interlayer and a second infrared transmissive substrate having a first and a second surface opposite the first surface, laminated, by its second surface to the second surface of the first infrared transmissive substrate, by means of said interlayer.

Clause 29: The infrared transmissive pane according to any one of clauses 1 to 28, wherein the first and/or second infrared transmissive substrate is independently selected from glass, polymethylmethacrylate (PMMA), polycarbonate (PC), polyvinyl chloride (PVC), polyethylene (PE), polybutylene (PB), or mixtures and composites of two or more of polymethylmethacrylate (PMMA), polycarbonate (PC), polyvinyl chloride (PVC), polyethylene (PE), polybutylene (PB).

Clause 30: The infrared transmissive pane according to any one of clauses 1 to 29, wherein the thickness of the first and/or the second infrared transmissive substrate independently ranges of from 0.5 mm to about 15 mm, alternatively of from 1 mm to about 10 mm, alternatively of from 1 mm to about 8 mm, alternatively of from 1 mm to about 6 mm, alternatively of from 0.5 to 4 mm.

Clause 31: The infrared transmissive pane according to clause 29, wherein the glass is an “infrared transmissive glass”, having an absorption coefficient lower than 15 m⁻¹ in the wavelength range from 750 to 1650 nm.

Clause 33: The infrared transmissive pane according to any one of clauses 1 to 30, wherein the first and/or second infrared transmissive substrates are “infrared transmissive glass”, having an absorption coefficient lower than 15 m⁻¹ in the wavelength range from 750 to 1650 nm.

Clause 34: The infrared transmissive pane according to any one of clauses 28 to 32, wherein the first surface of the second infrared transmissive substrate is provided with a second infrared antireflective coating.

Clause 35: The infrared transmissive pane according to clause 27 or 33, wherein the first and second infrared antireflective coatings are the same or different.

Clause 36: An optical assembly comprising the infrared transmissive pane according to any one of clauses 1 to 34, and an infrared sensitive receptor and/or an infrared light source, wherein the pane is configured to transmit infrared light to the sensor and/or from the source.

Clause 37: The optical assembly according to clause 35, wherein the infrared sensitive receptor and/or an infrared light to source is an emitting/receiving infrared optical sensor.

Clause 38: The optical assembly according to any one of clauses 35 or 36, wherein the infrared transmissive pane is the cover of the infrared sensitive receptor and/or an infrared light source.

Clause 39: A cover for an infrared sensitive sensor and/or an infrared light source for infrared light in the range of from 800 to 2000 nm comprising the infrared transmissive pane according to any one of clauses 1 to 34.

Clause 40: A LIDAR device comprising the cover according to clause 38.

Clause 41: The LiDAR device according to clause 39, where the infrared transmissive pane is provided with a opacifying coating.

Clause 42: A vehicle comprising the optical assembly according to any one of clauses 35 to 37.

Clause 43: A vehicle comprising the LiDAR according to any one of clauses 39 to 40.

Clause 44: Use of an infrared transmissive pane according to any one of clauses 1 to 34, as a cover for an infrared sensor and/or infrared light source.

Clause 45: Use of an infrared transmissive pane according to any one of clauses 1 to 34, in a LiDAR device.

### EXAMPLES

Infrared transmissive panes comprising an infrared transmissive substrate having a first surface and a second surface opposite to the first surface, and an infrared antireflective coating on the first surface were provided as described below and evaluated for their optical parameters in view of specific light conditions and in view of their capability for infrared transmission.

The infrared transmissive substrate used in the present examples was infrared transmissive glass (low iron, chromium containing float glass), clear, 1.6 mm thickness, thoroughly cleaned before any coating deposition.

All optical parameters are given for illuminant D65, 2° for reflection or transmission levels and illuminant D65, 10° for color indexes (a* and b*)—in the visible.

All optical thicknesses are considered with the refractive index of the material at the infrared operating wavelength indicated. Therefore, the thicknesses indicated in the tables below, unless otherwise indicated, are geometrical thicknesses, with the geometrical thickness=optical thickness/refractive index at the specified wavelength.

### Materials:

TZO: Titanium oxide/Zirconium oxide in a ratio 55/45 wt %, having a high refractive index of 2.19 (at 550 nm)
SiO₂: Silicon oxide exhibiting a low refractive index of 1.46 (at 550 nm)
SiZrO: Silicon oxide/Zirconium oxide in a ratio 65/35 wt %, having a low refractive index of 1.57 (at 550 nm)

Other refractive indices are provided for selected materials, as used herein.

| | | | | |
|---|---|---|---|---|
| n @ | n @ | n @ | n @ | n @ |
| 550 nm | 905 nm | 1064 nm | 1310 nm | 1550 nm |

Low refractive index materials

| | | | | | |
|---|---|---|---|---|---|
| MgF₂ | 1.423 | 1.419 | 1.418 | 1.417 | 1.418 |
| Al₂O₃ | 1.771 | 1.757 | 1.754 | 1.750 | 1.746 |
| SiO₂ | 1.470 | 1.467 | 1.466 | 1.466 | 1.465 |
| SiZrOₓ | 1.561 | 1.542 | 1.540 | 1.538 | 1.537 |

High refractive index materials

| | | | | | |
|---|---|---|---|---|---|
| TiO₂ | 2.481 | 2.376 | 2.362 | 2.350 | 2.344 |
| Si₃N₄ | 2.031 | 2.005 | 2.001 | 1.998 | 1.998 |
| Nb₂O₅ | 2.381 | 2.276 | 2.260 | 2.246 | 2.239 |
| TZO | 2.378 | 2.300 | 2.292 | 2.280 | 2.278 |

Chemical and mechanical stability will be evaluated per the following test methods, well known by the skilled person in the art.

Chemical durability in the scope of the present invention includes the test methods of the Cleveland test, the Climatic chamber test and the Salt fog test.

### Cleveland Test

The Cleveland test is run according to standard ISO 6270-1:1998, for at least 2 days, alternatively 5 days, alternatively 10 days, alternatively 15 days.

### Climatic Chamber Test (CC)

The test consists in placing the samples in a chamber filled with an atmosphere of H₂O and subjected to temperature cycles each of 2 hours, during which the temperature varies from 45° C. to 55° C. returning to 45° C., for at least 2 days, alternatively 5 days, alternatively 10 days, alternatively 21 days. CC BB is the test carried out before heat treatment of the pane (before bake), while CC AB is the test carried out after heat treatment of the pane (after bake)

### Salt Fog Test (NSST)

This test consists in subjecting the sample to the action, in a chamber maintained at 35° C., of a salt fog formed by spraying an aqueous solution containing 50 g/l sodium chloride (full details of this test are set out in International Standard ISO 9227-1990), for an exposure time of at least 5 days, alternatively at least 10 days, alternatively at least 21 days.

Mechanical durability in the scope of the present invention includes the test methods of the Automatic Wet Rub test, and the Dry Brush Test, before and after a thermal treatment.

### Automatic Wet Rub Test (AWRT)

A piston covered with a wet cotton cloth that is kept wet is brought into contact with the layer to be evaluated and moved back and forth over its surface. The piston bears a weight so as to apply a force of 33 N to a finger having a diameter of 17 mm. The rubbing of the cotton over the coated surface damages (removes) the layer after a certain number of cycles. The test is used to define the limit at which the layer discolors (partial removal of the layer) and scratches appear therein. The test is carried out for 10, 50, 100, 250, 500 and 1000 cycles in various separate locations on the sample. The sample is observed under an artificial sky in order to determine whether discoloration or scratching of the sample is visible in reflection. The AWRT result indicates the number of cycles resulting in no or very little degradation (invisible to the naked eye under a uniform artificial sky at a distance of 80 cm from the sample).

### Dry Brush Test

The dry brush test (DBT) is run according to standard ASTM D2486-00 (test method “A”), alternatively for at least 250 cycles, alternatively for at least 500 cycles. This test may also be carried out on samples after they have been subjected to heat treatment (here referred to as “bake”).

The results for each test described above are obtained by visually assessing samples in comparison with a defined scale of reference samples. Scales for the Cleveland climatic chamber and salt fog tests are based on an internal scale from 0 to 5, with 0 corresponding to a standard sample having critical deterioration (such as pixels, deep dots, stretch marks and so on). The value of 5 corresponds to a perfect or substantially perfect surface, free of any deterioration sign. The intermediate values (down to the 0.25 unit), correspond to samples of the internal scale having different levels of deterioration, ranked in order of level of deteriorations. Acceptable values are from 3 to 5. A second internal scale is set up for the DBT and AWRT tests, ranging from 0 to 10, with acceptable values of from 6 to 10. One value is typically the average of at least 3 samples for one experiment. Comparative examples in the tables below were prepared along the examples according to the invention as internal verification of the procedure for each “run” of experiment.

The bake conditions involve placing the sample inside a convection furnace at a temperature of 670° C. during 4 to 5 minutes.

Parameters measured were as follows:
a) Illuminant D65, 2°
Tv (%)=transmission level in the visible range
Rc (%)=reflection level coating side in the visible range
b) Illuminant D65, 10°
Rc a*=a* color index, reflection coating side, in the visible range, light incident at 8°
Rc b*=b* color index, reflection coating side, in the visible range, light incident at 8°
Rc60 a*=a* color index, reflection coating side, in the visible range, light incident at 60°
Rc60 b*=b* color index, reflection coating side, in the visible range, light incident at 60°
c) Infrared transmission at different specified operating wavelengths λ_{IR}, with light having an incident angle of 0°=T at λ_{IR} (%), and an incident angle of 60°=T60 at λ_{IR} (%)

Results generally indicate
transmission of infrared light is increased as compared to the uncoated infrared transmissive glass
when S=4, color is neutral: with −4<a*<1 and −5<b*<1 in coating-side reflection both at 0° and 60° (as defined above)

These results indicate the suitability of the infrared transmissive pane for the optimized transmission of infrared light.

### Examples 1 to 5

The antireflective coatings of Examples 1 to 5 were prepared with S=2, deposited on an infrared transmissive glass substrate of 1.6 mm as indicated in Table 1, with values as measured.

Deposition occurred with magnetron sputtering techniques.

Uncoated glass measures are also included for comparison purposes.

TABLE 1

| Material | | | | | | |
|---|---|---|---|---|---|---|
| (geometrical | | | | | | |
| thickness in nm) | Glass | Example 1 | Example 2 | Example 3 | Example 4 | Example 5 |
| λ_{IR} (nm) | | 905 | 1310 | 1550 | 1064 | 1064 |
| LB2—SiZrOx | — | 10 | 10 | 10 | 10 | 10 |
| LB1—SiO₂ | — | 147 | 220 | 266 | 168 | 141 |
| HB—TZO | — | 154 | 212 | 211 | 176 | 195 |
| LA—SiO₂ | — | 42 | 51 | 67 | 39 | 26 |
| HA—TZO | — | 21 | 42 | 67 | 31 | 15 |
| Substrate | | | | | | |

Σe_{H} (based on optical thickness values)

| | | | | | |
|---|---|---|---|---|---|
| λ_{IR} * | 0.44 | 0.44 | 0.41 | 0.44 | 0.45 |

RESULTS

| | | | | | | |
|---|---|---|---|---|---|---|
| Tv | 91.0 | 84.5 | 67.9 | 62.4 | 75.2 | 80.7 |
| Rc | 8.1 | 12.9 | 29.3 | 33.8 | 22.0 | 16.8 |
| Rc a* | −0.2 | 8.8 | 24.3 | 15.3 | −37.4 | −1.5 |
| Rc b* | −0.5 | −39.0 | −3.1 | −6.2 | −3.9 | −3.0 |
| Rc60 a* | −0.2 | 8.3 | −15.3 | 6.5 | 6.9 | −2.6 |
| Rc60 b* | −0.3 | −22.1 | 12.7 | 12.8 | −29.0 | −6.1 |
| T at 905 nm % | 92.0 | 94.5 | 84.2 | 77.9 | 94.6 | 93.9 |
| T at 1064 nm % | 92.1 | 94.9 | 92.5 | 74.6 | 95.1 | 94.9 |
| T at 1310 nm % | 92.1 | 90.3 | 95.0 | 93.2 | 94.6 | 93.3 |
| T at 1550 nm % | 92.1 | 83.5 | 95.1 | 95.3 | 89.8 | 85.9 |
| T60 at 905 nm % | 84.5 | 87.7 | 84.9 | 70.9 | 87.3 | 86.0 |
| T60 at 1064 nm % | 84.6 | 85.3 | 87.7 | 82.4 | 87.7 | 87.6 |
| T60 at 1310 nm % | 84.6 | 77.3 | 87.7 | 87.7 | 83.5 | 80.6 |
| T60 at 1550 nm % | 84.6 | 72.5 | 85.6 | 87.5 | 76.7 | 73.4 |

Values indicate that the antireflective coating improves the infrared transmission at the specific operating wavelength it is designed for, and optionally even beyond the strict operating wavelength for some. This may prove advantageous to provide for one coating suitable for multiple uses or applications.

Example 1 provides for an antireflective coating for operating wavelength of 905 nm, where the infrared transmission is increase from 92% (uncoated glass) to 94.5% at incident light of 0°, and from 84.5% to 87.7% at incident light of 60°. This gain in infrared light transmission is considered significant for the purpose of the end uses of the coatings.

Similar increases are observed for Example 2 at λ_{IR}=1310 nm, Example 3 at λ_{IR}=1550 nm, and Examples 4 and 5 at λ_{IR}=1064 nm.

Examples 4 and 5 exhibit different colors in reflection such as purple or greenish, which may not be considered neutral as defined herein.

Examples 1 to 5 exhibited a significantly improved chemical and mechanical durability as compared to the same coatings without the uppermost layer of SiZrOx.

### Examples 6 to 9

The antireflective coatings of Examples 6 to 9 were prepared with S=4, deposited on an infrared transmissive glass substrate of 1.6 mm as indicated in Table 2, with values as measured.

Deposition occurred with magnetron sputtering techniques.

Uncoated glass measures are also included for comparison purposes.

TABLE 2

| Material | | | | | |
|---|---|---|---|---|---|
| (geometrical | | | | | |
| thickness in nm) | Glass | Example 6 | Example 7 | Example 8 | Example 9 |
| λ_{IR} (nm) | | 905 | 1064 | 1310 | 1550 |
| LD2 - SiZrOx | — | 10 | 10 | 10 | 10 |
| LD1 - SiO₂ | — | 112 | 178 | 220 | 330 |
| HD - TZO | — | 10 | 24 | 20 | 10 |
| LC - SiO₂ | — | 47 | 33 | 57 | 39 |
| HC - TZO | — | 38 | 51 | 36 | 27 |
| LB - SiO₂ | — | 28 | 33 | 43 | 37 |
| HB - TZO | — | 39 | 31 | 31 | 27 |
| LA - SiO₂ | — | 47 | 60 | 60 | 60 |
| HA - TZO | — | 14 | 10 | 10 | 10 |
| Substrate | | | | | |

RESULTS

| | | | | | |
|---|---|---|---|---|---|
| Tv | 91.0 | 89.6 | 87.6 | 86.5 | 88.3 |
| Rc | 8.1 | 8.2 | 9.9 | 10.8 | 8.5 |
| Rc a* | −0.2 | −0.3 | 0.6 | −1.5 | −0.2 |
| Rc b* | −0.5 | −2.5 | −2.9 | −3.2 | −3.3 |
| Rc60 a* | −0.2 | 0.3 | −1.6 | −1.6 | −0.3 |
| Rc60 b* | −0.3 | −2.9 | −1.1 | −4.3 | −4.1 |
| T at 905 nm % | 92.0 | 94.1 | 91.5 | 90.1 | 88.2 |
| T at 1064 nm % | 92.1 | 95.3 | 94.1 | 90.3 | 83.5 |
| T at 1310 nm % | 92.1 | 91.3 | 94.7 | 94.5 | 87.5 |
| T at 1550 nm % | 92.1 | 86.9 | 91.2 | 95.2 | 93.4 |
| T60 at 905 nm % | 84.5 | 87.1 | 86.5 | 83.2 | 77.2 |
| T60 at 1064 nm % | 84.6 | 84.6 | 87.3 | 85.9 | 79.4 |
| T60 at 1310 nm % | 84.6 | 79.5 | 83.2 | 87.2 | 85.9 |
| T60 at 1550 nm % | 84.6 | 77.1 | 79.3 | 84.4 | 87.6 |

Values indicate that the antireflective coating improves the infrared transmission at the specific operating wavelength it is designed for, and optionally even beyond the strict operating wavelength for some. This may prove advantageous to provide for one coating suitable for multiple uses or applications.

Example 6 provides for an antireflective coating for operating wavelength of 905 nm, where the infrared transmission is increase from 92% (uncoated glass) to 94.1% at incident light of 0°, and from 84.5% to 87.1% at incident light of 60°. The coating is also effective at improving transmission of infrared light at an operating wavelength of 1064 nm, which shows the advantage of the present coating to be suitable for multiple wavelengths.

Similar increases are observed for Example 7 at λ_{IR}=1064 nm, Example 8 at λ_{IR}=1310 nm, and Example 9 at λ_{IR}=1550 nm. The coatings display effective light transmission at the designed operating wavelength, but also in a neighboring operating wavelength, showing flexibility for the end applications and uses.

This gain in infrared light transmission is considered significant for the purpose of the end uses of the coatings. Also noticeable is the antireflective effect (coating side) such that Rc remains <11%.

Examples 6 to 9 exhibit a neutral color with a* values of from −1.5 to 0.6, and values of b* of from −3.3 to −2.5, within the ranges as defined for the present invention.

Examples 6 to 9 exhibited a significantly improved chemical and mechanical durability as compared to the same coatings without the uppermost layer of SiZrOx.

All Examples 1 to 10 achieved a score of 5 on the scales for the Cleveland test after 15 days, for the climatic chamber test after 21 days, for the NSST test after 21 days. All Examples 1 to 10 achieved a score of 10 on the scale for the AWRT at 1000 cycles, before and after bake, and also for the dry brush test at 1000 cycles before and after bake.

### Comparative Examples 1 to 3

The antireflective coatings of Comparative Examples 1 to 3, not in the scope of the invention, were prepared with S=4, deposited on an infrared transmissive glass substrate of 1.6 mm as indicated in Table 3, with values as measured.

Deposition occurred with magnetron sputtering techniques.

Uncoated glass measures are also included for comparison purposes.

TABLE 3

| Material | | | |
|---|---|---|---|
| (geometrical | | | |
| thickness in nm) | Glass | CE 1 | CE 2 |
| λ_{IR} (nm) | | 905 | 905 |
| LD - SiO₂ | — | 10 | 13 |
| HD - TZO | — | 6 | 7 |
| LC - SiO₂ | — | 172 | 179 |
| HC - TZO | — | 40 | 39 |
| LB - SiO₂ | — | 219 | 180 |
| HB - TZO | — | 17 | 15 |
| LA - SiO₂ | — | 171 | 201 |
| HA - TZO | — | 16 | 21 |
| Substrate | | | |

RESULTS

| | | | |
|---|---|---|---|
| Tv | 91.0 | 72.6 | 63.6 |
| Rc | 8.1 | 24.5 | 34.0 |
| Rc a* | −0.2 | 27.5 | 21.0 |
| Rc b* | −0.5 | −6.8 | 22.3 |
| Rc60 a* | −0.2 | −33.7 | −20.8 |
| Rc60 b* | −0.3 | 3.3 | 21.5 |
| T at 905 nm % | 92.0 | 89.6 | 93.7 |
| T at 1064 nm % | 92.1 | 91.8 | 94.7 |
| T at 1310 nm % | 92.1 | 90.5 | 90.7 |
| T at 1550 nm % | 92.1 | 90.3 | 87.1 |
| T60 at 905 nm % | 84.5 | 83.9 | 86.5 |
| T60 at 1064 nm % | 84.6 | 82.9 | 83.5 |
| T60 at 1310 nm % | 84.6 | 82.7 | 79.7 |
| T60 at 1550 nm % | 84.6 | 84.1 | 80.7 |

Comparative Example 1 provides for an antireflective coating for operating wavelength of 905 nm with an optical thickness e_{UL} at a wavelength λ_{IR}=905 nm of the uppermost layer <λ_{IR}*0.12 (that is, an optical thickness of 905*0.12=108.6 nm, and thus for a SiO₂ layer, equals to a geometrical thickness of 108.6/1.467=74 nm), and the infrared transmission is actually decreased from 92% (uncoated glass) to 89.6% at incident light of 0°, and from 84.5% to 83.9% at incident light of 60°. Such a coating is not designed optimally for the specific operating wavelength.

Comparative Example 2 provides for an antireflective coating for operating wavelength of 905 nm with an optical thickness e_{UL} at a wavelength λ_{IR}=905 nm of the uppermost layer <λ_{IR}*0.12, where the infrared transmission is improved from 92% (uncoated glass) to 93.7% at incident light of 0°, and from 84.5% to 86.5% at incident light of 60°. However, the colors in transmission render this coating unsuitable for an application where it may be observed by an external viewer.

The durability of Comparative Examples 1 and 2 was extremely poor, rendering this coating unsuitable for an application where the coating would be in contact with the external environment. Indeed, Comparative Examples 1 and 2 achieved a score of 2 and 3.5 on the scales for the Cleveland test after 15 days, a score of 1 and 2 for the climatic chamber test after 21 days, a score of 3 and 2.5 for the NSST test after 21 days. Comparative Examples 1 and 2 achieved a score of 1.5 and 4.5 on the scale for the AWRT at 1000 cycles, before bake, and of 1 and 3.5 after bake.

### Example 10

The antireflective coating of Example 10 was prepared with S=2, deposited on an infrared transmissive glass substrate of 1.6 mm as indicated in Table 4, with values as measured. The high refractive index layers are composed of several sub-layers of high refractive index.

Deposition occurred with magnetron sputtering techniques.

Uncoated glass measures are also included for comparison purposes.

TABLE 4

| Material | | |
|---|---|---|
| (geometrical | | |
| thickness in nm) | Glass | Example 10 |
| λ_{IR} (nm) | | 905 |
| LB2 - SiZrOx | — | 30 |
| LB1 - MgF₂ | — | 140 |
| HB - TiO₂ | — | 153 |
| LA2 - SiO₂ | — | 5 |
| LA1 - MgF₂ | — | 30 |
| HA2 -TZO | — | 14 |
| HA1 - Si₃N₄ | — | 10 |
| Substrate | | |

Σe_{H} (based on optical thickness values)

| | |
|---|---|
| λ_{IR} * | 0.46 |

RESULTS

| | | |
|---|---|---|
| Tv | 91.0 | 78.0 |
| Rc | 8.1 | 21.0 |
| Rc a* | −0.2 | −2.7 |
| Rc b* | −0.5 | −18.3 |
| Rc60 a* | −0.2 | −10.5 |
| Rc60 b* | −0.3 | −14.5 |
| T at 905 nm % | 92.0 | 93.1 |
| T at 1064 nm % | 92.1 | 93.6 |
| T at 1310 nm % | 92.1 | 89.6 |
| T at 1550 nm % | 92.1 | 82.9 |
| T60 at 905 nm % | 84.5 | 87.9 |
| T60 at 1064 nm % | 84.6 | 85.6 |
| T60 at 1310 nm % | 84.6 | 76.7 |
| T60 at 1550 nm % | 84.6 | 71.6 |

Values indicate that the antireflective coating improves the infrared transmission at the specific operating wavelength it is designed for, namely 905 nm, and optionally even beyond the strict operating wavelength, namely up to 1064 nm. This may prove advantageous to provide for one coating suitable for multiple uses or applications.

Example 10 provides for an antireflective coating for operating wavelength of 905 nm, where the infrared transmission is increased from 92% (uncoated glass) to 93.1% at incident light of 0°, and from 84.5% to 87.9% at incident light of 60°. This gain in infrared light transmission is considered significant for the purpose of the end uses of the coatings.

### Examples 11 to 15

The antireflective coatings of Examples 11 to 15 were prepared with S=4, deposited on an infrared transmissive glass substrate of 1.6 mm as indicated in Table 5, with values as measured. The layers may be composed of several sub-layers of high or low refractive indices, respectively.

Deposition occurred with magnetron sputtering techniques.

Uncoated glass measures are also included for comparison purposes.

TABLE 5

| Material | | | | | | |
|---|---|---|---|---|---|---|
| (geometrical | | Example | Example | Example | Example | Example |
| thickness in nm) | Glass | 11 | 12 | 13 | 14 | 14 |
| λ_{IR} (nm) | | 905 | 905 | 1064 | 1310 | 1550 |
| LD2—SiZrOx | — | 10 | 50 | 30 | 6 | 150 |
| LD1 | — | SiO₂: 122 | MgF₂: 93 | SiO₂: 146 | MgF₂: 235 | SiO₂: 159 |
| HD2 | — | — | — | TZO: 7 | — | — |
| HD1 | — | TZO: 10 | Nb₂O₅: 40 | Si₃N₄: 12 | Nb₂O₅: 15 | TZO: 10 |
| LC2 | — | — | — | Al₂O₃: 37 | — | — |
| LC1 | — | SiO₂: 44 | MgF₂: 40 | SiO₂: 13 | MgF₂: 53 | SiO₂: 45 |
| HC2 | — | — | — | TZO: 25 | — | — |
| HC1 | — | TZO: 42 | TiO₂: 36 | Si₃N₄: 19 | Nb₂O₅: 35 | TZO: 31 |
| LB2 | — | — | — | Al₂O₃: 22 | — | — |
| LB1 | — | SiO₂: 32 | MgF₂: 34 | SiO₂: 10 | Al₂O₃: 40 | SiO₂: 38 |
| HB2 | — | — | — | TZO: 12 | — | — |
| HB1 | — | Nb₂O₅: 35 | Nb₂O₅: 30 | Si₃N₄: 25 | Nb₂O₅: 31 | TZO: 26 |
| LA2 | — | — | — | Al₂O₃: 25 | — | — |
| LA1 | — | MgF₂: 49 | MgF₂: 49 | SiO₂: 31 | SiO₂: 45 | SiO₂: 58 |
| HA2 | | — | — | — | Nb₂O₅: 4 | — |
| HA1 | — | Nb₂O₅: 14 | TiO₂: 9 | Si₃N₄: 11 | TZO: 6 | Si₃N₄: 12 |
| Substrate | | | | | | |

Σe_{H} (based on optical thickness values)

| | | | | | |
|---|---|---|---|---|---|
| λ_{IR} * | 0.26 | 0.29 | 0.20 | 0.16 | 0.12 |

RESULTS

| | | | | | | |
|---|---|---|---|---|---|---|
| Tv | 91.0 | 91.4 | 88.3 | 88.1 | 90.3 | 89.1 |
| Rc | 8.1 | 6.6 | 9.8 | 10.0 | 8.6 | 8.3 |
| Rc a* | −0.2 | −1.4 | −1.7 | −1.7 | −2.0 | 0.0 |
| Rc b* | −0.5 | −1.5 | −4.9 | −4.1 | −2.9 | −0.5 |
| Rc60 a* | −0.2 | −2.3 | −1.2 | −1.8 | −2.2 | 0.2 |
| Rc60 b* | −0.3 | −4.9 | −3.6 | −4.4 | −3.8 | −1.5 |
| T at 905 nm % | 92.0 | 94.2 | 94.6 | 91.2 | 86.3 | 83.3 |
| T at 1064 nm % | 92.1 | 95.5 | 95.4 | 94.3 | 87.3 | 80.6 |
| T at 1310 nm % | 92.1 | 91.7 | 91.7 | 94.9 | 93.7 | 87.9 |
| T at 1550 nm % | 92.1 | 86.8 | 87.6 | 91.3 | 95.0 | 94.1 |
| T60 at 905 nm % | 84.5 | 87.4 | 87.4 | 86.7 | 81.7 | 74.9 |
| T60 at 1064 nm % | 84.6 | 85.2 | 84.7 | 87.7 | 86.1 | 78.9 |
| T60 at 1310 nm % | 84.6 | 79.5 | 80.0 | 83.6 | 87.7 | 86.3 |
| T60 at 1550 nm % | 84.6 | 76.5 | 77.7 | 80.0 | 84.4 | 87.4 |

Values indicate that the antireflective coating improves the infrared transmission at the specific operating wavelength it is designed for, and optionally even beyond the strict operating wavelength for some. This may prove advantageous to provide for one coating suitable for multiple uses or applications.

Example 11 provides for an antireflective coating for operating wavelength of 905 nm, where the infrared transmission is increase from 92% (uncoated glass) to 94.2% at incident light of 0°, and from 84.5% to 87.4% at incident light of 60°. The coating is also effective at improving transmission of infrared light at an operating wavelength of 1064 nm, which shows the advantage of the present coating to be suitable for multiple wavelengths.

Similar increases are observed for Example 12 at λ_{IR}=905 nm, Example 13 at λ_{IR}=1064 nm, Example 14 at λ_{IR}=1310 nm, Example 15 at λ_{IR}=1550 nm. The coatings display effective light transmission at the designed operating wavelength, but also in a neighboring operating wavelength, showing flexibility for the end applications and uses.

This gain in infrared light transmission is considered significant for the purpose of the end uses of the coatings.

Examples 11 to 15 exhibit a neutral color with a* values of from −2.0 to 0.0, and values of b* of from −4.9 to −0.5, within the ranges as defined for the present invention.

Examples 11 to 15 exhibited a significantly improved chemical and mechanical durability as compared to the same coatings without the uppermost layer of SiZrOx.

Similar coatings may be obtained using other layers having a high refractive index, such as mixed oxide of titanium and zirconium, silicon nitride, mixed nitride of silicon and titanium, mixed nitride of silicon and zirconium, mixed nitride of silicon and hafnium, zirconium nitride, zirconium oxide, silicon doped zirconium oxide, mixed nitride of zirconium and boron, mixed oxide of zinc and tin, niobium oxide, aluminum doped zinc oxide and/or other layers having a low refractive index, such silicon oxide, silicon oxynitride, silicon oxycarbide, aluminum oxide, mixed silicon aluminum oxide, mixed silicon zirconium oxide, aluminium doped silicon oxide, boron doped silicon oxide.

1. (canceled)

2. The optical assembly according to claim 29, wherein S≥2, and wherein a sum of optical thicknesses at a wavelength λ_{IR} of the layers of high refractive index material Σe_{H}, of the infrared antireflective coating, ranges of from (λ_{IR}*0.10)≤Σe_{H}≤(λ_{IR}*0.55).

3. The optical assembly according to claim 29, wherein S=2 or 3, and wherein a ratio of a sum of optical thicknesses Σe_{L} of the layers having a low refractive index to a visible wavelength of 550 nm “Σe_{L}/550 nm” complies with the following equation regarding the infrared wavelength (λ_{IR})—in percentage:
$$( 0.0614 \times {λ}_{IR} ) - K 1 \leq Σ {e}_{L} / 550 nm \leq ( 0.0614 \times {λ}_{IR} ) - K 2 \\ with K 1 = 25 \% and K 2 = - 3 \% .$$

4. The optical assembly according to claim 29, wherein S=2 or 3, and wherein the optical thickness e_{UL} at a wavelength λ_{IR} of an uppermost layer having a low refractive index, of the infrared antireflective coating ranges from (λ_{IR}*0.15)≤e_{UL}≤(λ_{IR}*0.33).

5. The optical assembly according to claim 29, wherein S=2 or 3, and
wherein the optical thickness e_{UH} at a wavelength λ_{IR} of an uppermost layer having a high refractive index, of the infrared antireflective coating ranges from (λ_{IR}*0.25)≤e_{UH}≤(λ_{IR}*0.50).

6. The optical assembly according to claim 29, wherein S=2 or 3, and
wherein the optical thickness e_{LA} at a wavelength λ_{IR} of a lowermost layer having a low refractive index LA, of the infrared antireflective coating is e_{LA}≤(λ_{IR}*0.13).

7. The optical assembly according to claim 6, wherein S=2 or 3, and
wherein the optical thickness e_{HA} at a wavelength λ_{IR} of a lowermost layer having a high refractive index HA, of the infrared antireflective coating is e_{HA}≤(λ_{IR}*0.15).

8. The optical assembly according to claim 29, wherein S≥4, and
wherein an optical thickness e′_{UH} of an uppermost layer having a high refractive index UH, of the infrared antireflective coating ranges of from 15 to 110 nm.

9. The optical assembly according to claim 8, wherein S≥4, and
wherein an optical thickness e_{UL} of an uppermost layer having a low refractive index UL, of the infrared antireflective coating may also range of from (λ_{IR}*0.15)≤e_{UL}≤(λ_{IR}*0.37).

10. The optical assembly according to claim 29, wherein S=4, and
wherein both a ratio of a sum of the optical thicknesses of the layers of high refractive index material Σe_{H} (=e_{HA}+e_{HB}+e_{HC}+e_{HD}) to the selected λ_{IR}-ratio “(Σe_{H}/λ_{IR})” and
wherein a ratio of a sum of the optical thicknesses of the layers of low refractive index material apart from the uppermost layer Σe_{L}−e_{LD} (=e_{LA}+e_{LB}+e_{LC}) to the selected λ_{IR}-ratio “(Σe_{L}−e_{LD})/λ_{IR}” complies with the following equations regarding the infrared wavelength (λ_{IR})—in percentage:
$$( - 0.0017 \times {λ}_{IR} ) + K 3 \leq Σ {e}_{H} / {λ}_{IR} \leq ( - 0.0017 \times {λ}_{IR} ) + K 4 ,$$
with a minimum set at Σe_{H}/λ_{IR}≥5%,
and
$$( - 0.0017 \times {λ}_{IR} ) + K 3 \leq ( Σ {e}_{L} - {e}_{LD} ) / {λ}_{IR} \leq ( - 0.0017 \times {λ}_{IR} ) + K 4$$
with a minimum set at (Σe_{L}−e_{LD})/λ_{IR}≥5%
and with K3=30% and K4=50%.

11-28. (canceled)

29. An optical assembly comprising:
an infrared transmissive pane; and
an infrared sensitive receptor and/or an infrared light source,
the infrared transmissive pane further comprising a first infrared transmissive substrate having a first surface and a second surface opposite to the first surface, and an infrared antireflective coating on the first surface,
wherein the coating comprises S sequence(s) of thin layers,
wherein each sequence of thin layers comprises a layer of high refractive index material underneath a layer of low refractive index material,
wherein S≥2,
wherein an optical thickness e_{UL} at a wavelength λ_{IR}, of an uppermost layer of the coating comprising the low refractive index material ranges from (λ_{IR}*0.12)<e_{UL}≤(λ_{IR}*0.40),
wherein λ_{IR} is an infrared wavelength selected in range of 800 to 2000 nm, and
wherein the pane is configured to transmit infrared light to the sensor and/or from the source.

30. The optical assembly according to claim 29, wherein the infrared sensitive receptor and/or the infrared light source is an emitting/receiving infrared optical sensor.

31. The optical assembly according to claim 29, wherein the infrared transmissive pane is a cover of the infrared sensitive receptor and/or an infrared light source.

32. A cover for an infrared sensitive sensor and/or an infrared light source for infrared light in the range of from 800 to 2000 nm comprising the infrared transmissive pane of the optical assembly according to claim 29.

33. A LiDAR device comprising the cover according to claim 32.

34. The LiDAR device according to claim 33, where the infrared transmissive pane is provided with an opacifying coating.

35. A vehicle comprising the optical assembly according to claim 29.

36. A vehicle comprising the LiDAR according to claim 33.

37. The optical assembly according to claim 29, wherein the infrared transmissive pane is suitable as a cover for an infrared sensor and/or infrared light source.

38. The optical assembly according to claim 29, wherein the infrared transmissive pane is provided with a LiDAR device.
